(19) United States
(12) Patent Application Publication
(10) Pub. No.: US 2012/0084432 A1
(43) Pub. Date: Apr. 5, 2012

(54) METHOD AND APPARATUS FOR PROTOCOL EVENT MANAGEMENT

(76) Inventors: Greg F. Soprovich, Ottawa (CA); Reza Rokui, Kanata (CA); Lei Qiu, San Ramon, CA (US)

(21) Appl. No.: 12/894,733

(22) Filed: Sep. 30, 2010

(51) Int. Cl. G06F 15/16

(52) U.S. Cl. 709/224

(57) ABSTRACT

A protocol event management capability is depicted and described herein. The protocol event management capability is provided by enhancing current network element behavior and coupling the enhancements to the management system managing the network element. A first enhancement is use of protocol event capture, in which the network element logs protocol events locally at the network element. A protocol event logged for an event related to a protocol includes a description of the event related to the protocol and an association of the event related to the protocol to at least one object impacted by the event related to the protocol. The logged protocol events may be provided to the management system in any suitable manner. A second enhancement is use of protocol event suppression, in which the network element suppresses protocol events using protocol event suppression rules, and the management system reconstructs the suppressed protocol events using knowledge of the protocol event suppression rules applied at the network element. The protocol event capture function and protocol event suppression function may be used independently or in combination.

### FIELD OF THE INVENTION

The invention relates generally to communication networks and, more specifically but not exclusively, to management of protocols of communication networks.

### BACKGROUND

Network Management Systems (NMSs) are employed for managing various aspects of communication networks. In certain types of networks, NMSs may be employed for managing multicast protocols (e.g. Protocol Independent Multicast (PIM), Internet Group Management Protocol (IGMP), and the like). Effective management of multicast protocols by an NMS requires accurate discovery, high fidelity, and large scale. The first two requirements—accuracy & fidelity—imply that the NMS needs to able to effectively deduce topology and stay ‘in sync’ in a timely manner. The third requirement—large scale—implies a need to support hundreds or thousands of routers having, potentially, very high multicast state. The applications of a multicast topology, such as the routing of (Source, Group) ((S,G)) trees in PIM, include trouble shooting histories, early detection of failure conditions and events, effective auditing, and impact analysis of network events upon multicast services. Modern services, such as IP-TV or business multicast, can be impaired by transient events and, therefore, a more near real time view of the network and multicast paths is essential for understanding the current status, generating timely alarms, and for root cause analysis.

For management of multicast protocols, a few different approaches are commonly used. A first approach is for the NMS to rely upon brute force polling (e.g., Simple Network Management Protocol (SNMP) Management Information Bases (MIBs) and associated traps, multicast routing tables, and the like) in an effort to reconcile the current protocol and path topologies in the NMS. For example, all PIM (S,G) states across all routers may be polled in order to deduce the multicast path through the network via KCBs. Similarly, for example, a routing approach may be used by pulling the multicast Routing Information Bases (RIBs) from the router and then computing the multicast paths in the network. A second approach is to use a combination of inference and simulation to try to derive what should be happening to the multicast paths within the network.

Disadvantageously, however, there are many problems associated with such approaches. First, at least some such approaches require huge amounts of messaging within the network, which may degrade the performance of elements involved in the messaging and the overall performance of the network. Second, such approaches are generally ineffective at detecting short term transients, events due to software or protocol bugs, or problems outside of the management domain that are injected into the system via peering. For example, transients are commonly missed and often cannot be tied to a root cause in inference/simulation environments, at least because there is inadequate topology information in the NMS. Moreover, such approaches have great difficulty in deducing the network state at a given time, at least because poll/reconcile cycles have no time information that can be used to derive the current network state globally. Thus, scalability considerations and lack of data visibility pose major challenges to providing a solution for network troubleshooting, post event analysis, and early alerting to system problems.

### SUMMARY

Various deficiencies in the prior art are addressed by embodiments for managing protocol events within communication networks using a protocol event management capability.

Various embodiments of the protocol event management capability are provided by enhancing current network element behavior of the network elements and coupling the enhancements to the management system managing the network elements. A first enhancement is use of protocol event capture, in which the network element generates protocol events and logs the protocol events locally at the network element. A protocol event logged for an event related to a protocol includes a description of the event related to the protocol and an association of the event related to the protocol to at least one object impacted by the event related to the protocol. The logged protocol events may be provided to the management system in any suitable manner. A second enhancement is use of protocol event suppression, in which the network element suppresses protocol events using protocol event suppression rules, and the management system reconstructs the suppressed protocol events using knowledge of the protocol event suppression rules applied at the network element. The protocol event capture function and protocol event suppression function may be used independently or in combination.

In one embodiment, a method for protocol management is provided. The method includes detecting, at a network element of a communication network, an event related to a protocol running in the communication network, generating a protocol event describing the event related to the protocol, and writing the protocol event to a protocol event log maintained by the network element of the communication network, where the protocol event includes a description of the event related to the protocol and an association of the event related to the protocol to at least one object impacted by the event related to the protocol.

In one embodiment, a method for protocol management is provided, The method includes detecting, at a network element of a communication network, an event related to a protocol running in the communication network, and suppressing, at the network element, generation of a protocol event for the event related to the protocol, where generation of a protocol event for the event related to the protocol is suppressed when a determination is made that a protocol event suppression rule indicates that generation of a protocol event for the event related to the protocol is to be suppressed.

### BRIEF DESCRIPTION OF THE DRAWINGS

The teachings herein can be readily understood by considering the following detailed description in conjunction with the accompanying drawings, in which:

FIG. 1 depicts an exemplary multicast communication system illustrating one embodiment of protocol event management;

FIG. 2 depicts one embodiment of a method for providing protocol event logging at a network element of a communication network;

FIG. 3 depicts one embodiment of a method for providing protocol event suppression at a network element of a communication network;

FIG. 4 depicts one embodiment of a method for processing a protocol event at a management system;

FIG. 5 depicts one embodiment of a method for processing a protocol event at a management system based on protocol event suppression; and

FIG. 6 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

A protocol event management capability is depicted and described herein. The protocol event management capability enables efficient and scalable management of protocol events.

Although the protocol event management capability is primarily depicted and described herein within the context of management of multicast protocols of multicast networks, it will be appreciated that the protocol event management capability may be used for managing protocol events of any other suitable types of protocols in any other suitable types of communication networks.

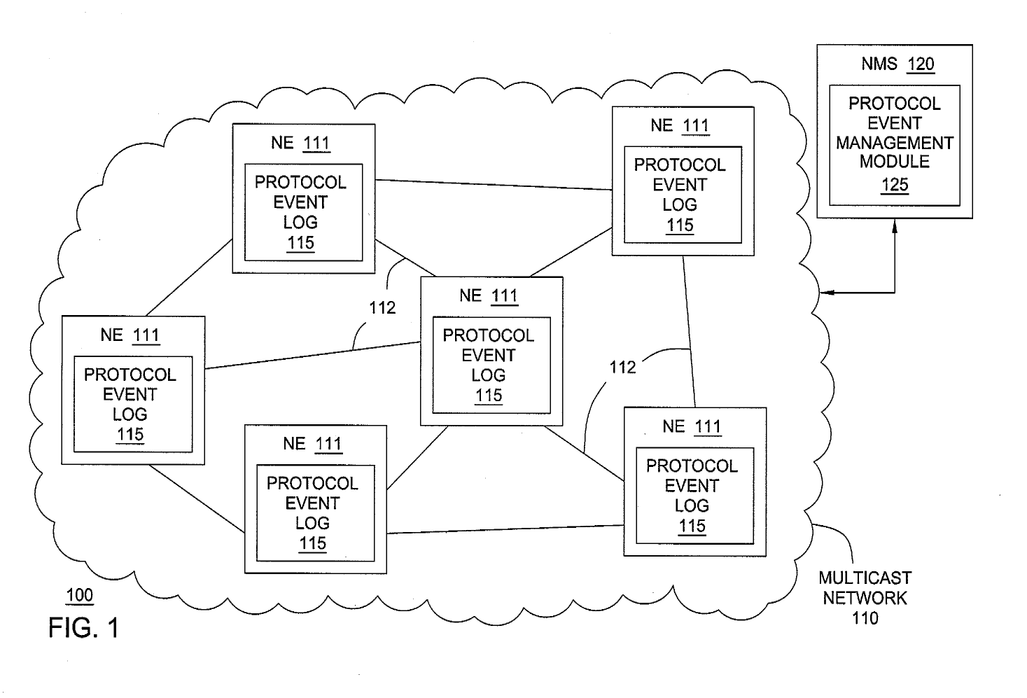

FIG. 1 depicts an exemplary multicast communication system illustrating one embodiment of protocol event management.

As depicted in FIG. 1, exemplary multicast communication system 100 includes a multicast network 110 and a network management system (NMS) 120. The multicast network 110 runs one or more multicast protocols (e.g., Protocol Independent Multicast (PIM), Internet Group Management Protocol (IGMP), Distance Vector Multicast Routing Protocol (DVMRP), and the like) supporting multicasting within multicast network 110.

The multicast network 110 includes a plurality of network elements (NEs) 111 (collectively, NEs 111) in communication via a plurality of communication paths (CPs) 112 (collectively, CPs 112), which support multicasting of traffic within multicast network 110. For example, as depicted in FIG. 1, the NEs 111 include switches and routers. The NEs 111 are configured to detect events associated with multicast protocols running within multicast network 110. The NEs 111 are configured to intelligently generate protocol events for at least a portion of the detected events, and to intelligently enable the generated protocol events to be available to NMS 120 using various functions of the protocol event management capability, thereby enabling the NMS 120 to maintain a current view of the state of the multicast network 110.

The NMS 120 provides various management functions for multicast network 110. The NMS 120 is configured to receive protocol events generated by the NEs 111, and to process the received protocol events for providing various management functions typically performed by management systems using protocol events. The NMS 120 is configured to support various functions of the protocol event management capability, thereby enabling the NMS 120 to maintain a current view of the multicast topology of multicast network 110 in a more efficient and scalable manner than is possible for existing management systems. Although primarily depicted and described with respect to management functions related to multicast topology logging, it will be appreciated that NMS 120 may be configured to perform any other network management functions for multicast network 110.

In one embodiment, the protocol event management capability is provided by enhancing current NE behavior (illustratively, of NEs 111) in two areas and coupling the enhancements to the NMS (illustratively, NMS 120). In this embodiment, the two enhancements of NE behavior include protocol event capture and protocol event suppression. This is depicted in FIG. 1 as a plurality of NE protocol event logs 115 implemented on the plurality of NEs 111, respectively, and as a protocol event management module 125 implemented on NMS 120. The protocol event logs 115 are configured for storing protocol events generated by the NEs 111 respectively. The protocol event management module 125 is configured for providing various protocol event management functions depicted and described herein as being provided by NMS 120 (e.g., receiving protocol events logged in protocol event logs 115 of NEs 111, configuring protocol event suppression rules used by NEs 111, and the like, processing protocol events for providing various management functions, and the like, as well as various combinations thereof).

In one embodiment, an NE 111 supports the first enhancement of NE behavior, which is generation of protocol events for supported multicast protocols.

In this embodiment, the NE 111 generates protocol events for the multicast protocol(s) supported by the NE 111 in response to detecting events associated with the multicast protocol(s) supported by the NE 111, where the generated protocol events describe the detected events in response to which the protocol events are generated, respectively.

In this embodiment, the NE 111, in response to generating protocol events, makes the generated protocol events available for use by NMS 120 in performing various management functions.

In one embodiment, protocol events generated by the NEs 111 are made available to NMS 120 by writing the generated protocol events into a plurality of protocol event logs 115 maintained by the plurality of NEs 111, respectively. The writing of captured protocol events into local protocol event logs 115_{L} may be performed in any suitable manner (e.g., using any suitable format, using any suitable information, and the like). The use of such a local logging embodiment reduces overhead associated with SNMP and like messaging protocols. In this embodiment, the NEs 111 may periodically send protocol events of the protocol event logs 115 to NMS 120 (e.g., periodically, in response to a local trigger condition, and the like) and/or NMS 120 can request on-demand reads of the protocol event logs 115 for obtaining protocol events of the protocol event logs 115 (e.g., periodically, in response to a local trigger condition, and the like).

In one embodiment, protocol events generated by the NEs 111 are made available to NMS 120 by configuring the NEs 111 to provide the protocol events to the NMS 120 as the protocol events are generated by the NEs. In this embodiment, the protocol events may be provided from the NEs 111 to the NMS 120 in any suitable manner, e.g., via an extended event interface (e.g., SNMP traps, Netflow, Syslog, and the like), via a streamed interface (e.g., using, Java Message Service (JMS)/Extensible Markup Language (XML) or any other suitable streamed interface), and the like, as well as various combinations thereof. In one such embodiment, in which the protocol events are provided to the NMS 120, message bundling may be employed for reducing overhead in propagation of protocol events to NMS 120. This embodiment may be used in place of and/or in addition to use of protocol event logs 115 for making protocol events available to NMS 120.

The protocol events may be generated in any suitable format, e.g., in an NMS-readable format, which may depend on the manner in which the protocol events are generated and logged by the NEs 111. In other words, the generated protocol events may be specified by the NEs 111, and provided to NMS 120, using any suitable machine-readable format(s), thereby enabling efficient processing of the logged protocol events.

In one embodiment, a generated protocol event includes information for use by the NMS 120 in performing management functions associated with protocol management (e.g., deriving current topology, reconstructing the historical multicast topology, and the like, as well as various combinations thereof).

In one embodiment, a protocol event generated in response to detection of an event related to a protocol includes (1) a description of the event related to the protocol and (2) an association of the event related to the protocol to one or more objects affected by the event related to the protocol. The event related to the protocol also may be referred to herein as the event which triggered generation of the protocol event.

The description of the event related to the protocol may include any information suitable for use in describing the event related to the protocol, such as one or more of event type indicators (e.g., join, leave, and the like), event timing information (e.g., in the form of an NE-determined time stamp for the event related to the protocol), information for use in deriving topology, event root cause information, and like information suitable for describing the event related to the protocol and which may be used by the NMS 120 in performing management functions associated with protocol management, as well as various combinations thereof. It will be appreciated that, in some cases, there may be some overlap at least some of these types of information.

The association of the event related to the protocol t to one or more objects affected by the event related to the protocol may include one or more associations to one or more objects, which may include physical objects and/or logical objects. For example, objects may include ports, interfaces (e.g., inbound protocol interfaces (IIFs), outbound protocol interfaces (OIFs), and the like), protocol objects, and the like, as well as various combinations thereof. The correlation of events to affected objects is performed by the NEs 111, thereby obviating the need for the NMS 120 to perform such correlation processing, thereby improving the processing load on NMS 120. The correlation of events to affected objects enables NMS 120 to perform management functions associated with protocol management.

In one embodiment, generated protocol events are time stamped. In one such embodiment, generated protocol events are time stamped locally by the NEs 111 (as opposed to in existing messaging systems in which protocol events are time stamped remotely at the receiver). In this embodiment, time stamping may be performed using any time source suitable for providing reliable time stamps for the generated protocol events (e.g., Network Time Protocol (NTP), syncE, Building Integrated Timing Supply (BITS), and the like). The use of time stamping in this manner greatly facilitates reconciliation during management processing performed by NMS 120.

In one embodiment, message numbering may be used for simplifying management of protocol event logs 115 and associated use of protocol event logs 115 by NMS 120 for performing management functions. This feature may be provided in place of or in addition to use of time stamping. In one embodiment, generated protocol events include information configured for use by the NMS 120 in deriving topology. For example, generated protocol events may include event type indicators (e.g., join, leave, and the like), logically associated connectivity information (e.g., inbound protocol interfaces, outbound protocol interfaces, and the like), and the like, as well as various combinations thereof. In the case of PIM, for example, this may include SNMP tables for neighbors, (S,G) channels, rendezvous point(s), and the like, as well as various combinations thereof. In the case of other types of multicast protocols, for example, this may include information from Multicast Routing Information Bases (MRIBs) and other suitable sources of state information.

In one embodiment, generated protocol events include information related to the root cause of changes where such information is known by the associated protocol. For example, such information may include information indicative of the failure of a neighbor forcing IGMP leaves, physical interface failures, and the like. This type of root cause information is configured for use by the NMS 120 in performing various related management functions.

In one embodiment, generated protocol events include an indication of use of protocol event suppression by NEs 111 when protocol event suppression has been employed by NEs 111. In one embodiment, when protocol event suppression is employed by NEs 111 using protocol event suppression rules configured on the NEs 111, use of protocol event suppression rules by NEs 111 indicate to the NEs 111 that use of protocol event suppression may need to be indicated to the NMS 120 in one or more other protocol events generated by the NEs 111 for the NMS 120. In various embodiments, protocol event suppression includes suppression of protocol events that are logically redundant, which involve suppression of the same or similar protocol events/protocol event messages, suppression of related protocol events/protocol event messages, and the like, as well as various combinations thereof. The indication of use of protocol event suppression indicates to the NMS 120 that the NMS 120 may need to deduce one or more protocol events related to the protocol event which includes the indication of use of protocol event suppression. In the case of PIM, for example, if a PIM neighbor of an NE 111 fails and the NE 111 uses protocol event suppression when capturing the event, the NMS 120, having knowledge of use of protocol event suppression by the NE 111, can clearly deduce all impacted (S,G) channels assuming discovery of the (S,G) state. As described herein, use of protocol event suppression provides scalability while also obviating the need for existing brute force approaches to scaling logging/streaming of protocol events to the NMS 120. Various embodiments of protocol event suppression are described herein.

As described herein, protocol event logs 115 of NEs 111 store protocol events generated by NEs 111, respectively. Thus, the protocol event logs 115 may be considered to include any information which may be included as part of or otherwise associated with protocol events maintained in protocol event logs 115. The protocol events may be organized within protocol event logs 115 of NEs 111 in any suitable manner (e.g., using XML format or any other suitable format, using file format, using streaming, and the like).

In one embodiment, when protocol events are captured in protocol event logs 115, the protocol event logs 115 (and, thus, the captured protocol events) may be made available to the NMS 120 in any suitable manner (e.g., at any suitable time, in response to any suitable trigger condition(s), and the like, as well as various combinations thereof). For example, an NE 111 may initiate propagation of protocol events from its protocol event log 115 to NMS 120 without receiving a request from NMS 120 (e.g., periodically, in response to detecting a condition associated with the size of the protocol event log 115 (e.g., in response to detecting that a size of the protocol event log 115 has reached a threshold, in response to detecting that a rate at which protocol events are being written to the protocol event log 115 satisfies a threshold, and so on), and the like, as well as various combinations thereof). For example, an NE 111 may initiate propagation of protocol events from its protocol event log 115 to NMS 120 in response to receiving a request from NMS 120. For example, an NE 111 may initiate propagation of protocol events from its protocol event log 115 to NMS 120 in response to any other suitable trigger condition, which may originate locally or remotely. This allows the NMS 120 to reconcile on demand (e.g., after a major event, during troubleshooting, and the like). In one embodiment, when protocol events are written to protocol event logs 115, the protocol event logs 115 are configured to roll over after being read by the NMS 120, as this avoids excess or spurious processing. It will be appreciated that, in embodiments in which the protocol events are propagated from NEs 111 to NMS 120 rather than writing the protocol events in the protocol event logs 115, such readout or rollover capabilities would not be used, as the NMS 120 would receive the protocol events as the protocol events occur. Thus, in at least some embodiments, log-based capture of protocol events may be preferred over real-time delivery of protocol events without log-based capture, due to the potential challenge of dealing with high protocol event rates that cannot be suppressed via local rules on the NEs 111.

The various embodiments of protocol event capture provide many advantages related to management of multicast protocols and related management functions. The logging of protocol events significantly reduces the messaging required between network elements and the management system, and provides an overall reduction in processing over existing polling techniques. The logging of protocol events allows reconciliation of short term events. The generation of time-stamped protocol events addresses key topology problems by capturing missed events, reducing processing to changes alone, simplifying reconciliation, and the like, as NMS 120 will know when changes occurred in the network. The availability of time-stamped protocol events and associated protocol event information, along with relevant topology information, enables the NMS 120 to reconstruct topology changes within the network. The capture of protocol events according to such embodiments provides various other benefits.

In one embodiment, each of the NEs 111 supports the second enhancement of NE behavior, which is protocol event suppression. In this embodiment, the NEs 111 are configured to suppress certain protocol events for supported multicast protocols. The use of protocol event suppression on the NEs 111 is adapted to reduce unnecessary messaging from the NEs 111 toward the NMS 120. This type of reduction is beneficial under various conditions (e.g., during major events, in large networks, and the like) and for various reasons (e.g., for reducing messaging load, for reducing processing load, and the like).

In one embodiment, the protocol event suppression is intelligent protocol event suppression, providing suppression of protocol events based on protocol event suppression rules configured for controlling protocol event suppression under various conditions.

The protocol event suppression rules are configured on the NEs 111. The protocol event suppression rules may be configured on the NEs 111 in any suitable manner, and may be static and/or dynamic. In one embodiment, the protocol event suppression rules are pre-configured on the NEs 111. In this embodiment, the protocol event suppression rules may be configurable on a per-rule basis for enabling the protocol event suppression rules to be activated/deactivated on the NEs 111 as needed or desired (e.g., in response to commands issued from the NMS 120 or any other suitable source). In one embodiment, the protocol event suppression rules may be configured on the NEs 111 by providing the protocol event suppression rules to the NEs 111 as needed or desired. In this embodiment, the protocol event suppression rules may be installed on the NEs 111 and removed from the NEs 111, as needed or desired, under the control of any suitable device (e.g., NMS 120 or any other suitable source of such configuration changes). The configuration of NEs 111 to support protocol event suppression rules may be performed using combinations of such embodiments and/or in any other suitable manner. In such embodiments, by enabling dynamic configuration of protocol event suppression rules on the NEs 111 (e.g., via one or more of enabling/disabling of protocol event suppression rules, installation/removal of protocol event suppression rules, and the like), protocol event capture performed by the NEs 111 may be tuned based on any suitable factor or factors (e.g., the network application, the current state of the network, and the like, as well as various combinations thereof).

The protocol event suppression rules used by the NEs 111 also may be configured on NMS 120 such that the NMS 120 has knowledge of the protocol event suppression rules used by the NEs 111 to suppress protocol events, thereby enabling the NMS 120 to reconstruct, via knowledge of protocol event suppression rules applied by the NEs 111, information associated with suppressed protocol events suppressed by the NEs 111. In one embodiment, protocol event suppression at the NEs 111 may be tunable, such as where protocol event suppression is tuned by the NMS 120 by adjusting, in concert, both (1) the protocol event suppression rules of the NEs 111, and (2) the protocol event suppression rules of the NMS 120 (i.e., so that the NMS 120 has knowledge of the current protocol event suppression rules being applied by the NEs 111), The tuning, by NMS 120, of protocol event suppression rules applied by NEs 111, may be performed for various reasons, such as, for example, to suit the application for which the multicast protocol is being used (e.g., in an Internet Protocol Television (IPTV) application, the NMS 120 might reconstruct (S,G) OIF events due to loading, whereas a transport scenario might maintain them).

In one embodiment, protocol event suppression rules are specified on a per-protocol basis. For example, the protocol event suppression rules used for PIM may be different than the protocol event suppression rules used for IGMP, and so forth (e.g., the rules may be different under various conditions, such as when dealing with peak events).

In various embodiments, protocol event suppression includes suppression of protocol events that are logically redundant, which involve suppression of the same or similar protocol events/protocol event messages, suppression of related protocol events/protocol event messages, and the like, as well as various combinations thereof.

In one embodiment, protocol event suppression rules are provided for enabling suppression of logically redundant protocol events. The suppression of logically redundant protocol events may be provided via protocol-appropriate sets of protocol event suppression rules. For example, a protocol event suppression rule may specify suppression of all (S,G) state when an IIF fails for physical link, network, or PIM protocol causes. In this example, the NE 111 writes a single protocol event to the protocol event log 115 of the NE 111 (e.g., a message specifying an IIF failure, which also may include a time stamp, associated interface information, and the like, as described herein with respect to embodiments of protocol event capture), and the NMS 120 is configured to be able to unambiguously deduce upstream (S,G) state from current logs and a one-time topology read (e.g., via SNMP). It will be appreciated that, in many cases, use of such protocol event suppression rules results in efficient suppression of large state transitions to only a small number of protocol events, thereby resulting in a dramatic increase in scale.

In one embodiment, for example, unnecessary messaging may be reduced by suppressing protocol events where correlation of protocol event suppression rules would reasonably allow the NMS 120 to deduce the impact of the suppressed protocol events. For example, failure of an IIF of an NE 111 could impact hundreds of IGMP joins; however, assuming that the NMS 120 is aware of the IGMP tree, a single protocol event (e.g., a single IIF message) for the protocol is sufficient to enable the NMS 120 to deduce the impact of the IIF failure. It will be appreciated that this is merely one example of the types of protocol event suppression which may be performed.

In one embodiment, protocol event suppression rules are configured such that protocol events are not suppressed where an unambiguous deduction cannot be made by the NMS 120. For example, (S,G) leaves may be suppressed for an IIF that is down, but (S,G) joins are not suppressed for other interfaces.

In one embodiment, protocol event suppression rules are configured to suppress protocol events due to processing load conventions. In at least some such embodiments, however, it may be necessary or desirable to add additional messages and logic to both the NE 111 and the NMS 120 so that the full protocol event can be reconstructed. For example, if a protocol interface undergoes a flap in a dual upstream environment, the NE 111 might indicate switching start and end times for 250 upstream (S,G) to the backup interface as an optimization. Similarly, for example, a similar reduction could be achieved when switching back at the cost of some relatively small fidelity and dramatic logging efficiencies.

In one embodiment, NEs 111 are configured to indicate to NMS 120, via messages (e.g., SNMP traps or similar messages) to NMS 120, that high protocol event rates are occurring in the network. This type of message provides an indication to the NMS 120 that a major event has occurred and that the NMS 120 should or may take action to maintain management fidelity (e.g., to maintain an accurate view of the current state of the network).

In one embodiment, NEs 111 are configured to indicate to NMS 120, via messages (e.g., SNMP traps or similar messages) to NMS 120, that high protocol event rates are no longer occurring in the network. This type of message provides an indication to the NMS 120 that no additional back off is required and that the NMS 120 may benefit from immediate collection of information from the protocol event logs 115 of the NEs 111.

In one embodiment, the NEs 111 are configured to provide a full dump of protocol state for reconciliation purposes, thereby obviating the need to use SNMP or other event reporting protocols for synchronization at startup or after loss of connectivity. This type of protocol event capture is similar to generation of check points, and may be facilitated via use of a new message type (e.g., as this is not an event-driven write to the protocol event logs 115).

In one embodiment, the NEs 111 are configured to propagate at least some protocol events toward the NMS 120, in addition to and/or in place of logging the protocol events in the protocol event logs 115. The protocol events that are propagated may be any suitable protocol events (e.g., high priority protocol events, protocol events associated with certain types of network conditions, and the like). The propagation of protocol events from NEs 111 toward the NMS 120 may be performed in response to any suitable condition or conditions (e.g., in low load situations, in response to high-priority conditions within the network, and the like, as well as various combinations thereof). The protocol events may be propagated using any suitable types of messages (e.g., SNMP traps or similar messages). It will be appreciated that, in at least some such embodiments, event feeds may be enhanced to also support the improved capture format and, therefore, that a streaming approach may be preferred in many such cases.

The suppression of protocol events in this manner is beneficial, because high message counts impact scalability in various potential solutions and, further, because protocols generally have large message counts that are not needed when a high fidelity model is used.

As depicted in FIG. 1, these and other functions associated with the first and second enhancements of NE behavior may be provided by the NEs 111, respectively.

As described above, these behavioral enhancements to NEs 111 are coupled to the NMS 120.

The NMS 120 is configured to utilize the NE enhancements (e.g., protocol event capture and/or protocol event suppression) for performing various management functions for multicast network 110 (e.g., reconciling multicast topology, reconciling multicast protocol state, and the like, as well as various combinations thereof).

In one embodiment, NMS 120 leverages the NE enhancements by (1) using protocol event capture to maintain a synchronized view of protocol state (e.g., receiving and processing protocol events logged on protocol event logs 115 of NEs 111) and (2) maintaining information (e.g., protocol event suppression rules, topology models/rules, and the like) that meshes to the protocol event suppression rules employed by the NEs 111. This enables the NMS 120 to re-create appropriate state changes within the NMS 120, as needed, in order to achieve an end-to-end protocol view. For example, suppression of replacing 50 (S,G) state changes at 10 NEs with IIF/OIF messages can save the processing of 500 events while the NMS 120 will still be able to use its topology model in order to re-create a change history for each (S,G), and a user could then be shown how the path of a tree changed in the multicast network 110 during the event (e.g., for purposes of post-analysis planning, trouble shooting, and the like).

In one embodiment, as described with respect to the NEs 111, protocol event capture and/or protocol event suppression are provided within the context of protocol event logging, whereby protocol events are logged in protocol event logs 115 by the NEs 111. In one such embodiment, the NMS 120 uses the protocol event logging as the primary method for performing such management functions. For example, since the protocol event logs 115 of the NEs 111 can be read at any time, and various types of protocol events may be suppressed from inclusion within the protocol event logs 115, only the relevant protocol events need to be obtained and processed by the NMS 120, providing significant optimization for the NMS 120. Similarly, for example, where the protocol events of the protocol event logs 115 are time-stamped and/or consolidated, execution of management functions is simplified for the NMS 120, thereby enabling the NMS 120 to differentiate between transient and long term events and conditions (e.g., between transient and long term network topology). In such embodiments, post-processing of protocol events from protocol event logs 115 and network information available at NMS 120 (e.g., network topology information, protocol state information, and the like) may be used to support various types of user functionality (e.g., generating and presenting one or more of alarms on (S,G) paths, generating and presenting a history of (S,G) paths, and the like, as well as various combinations thereof).

In one embodiment, the NMS 120 is configured to use a global reconcile function to capture initial network topology. The global reconcile function may be performed in any suitable manner (e.g., using SNMP or any other suitable capability). It will be appreciated that, while a global reconcile may not be ideal in certain situations, a one-time global reconcile is acceptable from a scaling perspective. In one embodiment, the NEs 111 may be configured to dump check points of the topology to the protocol event logs 115, thereby reducing the need for use of such global reconcile functions by the NMS 120.

In one embodiment, the NMS 120 is configured to periodically retrieve the protocol event logs 115 of the NEs 111. The NMS 120 uses the protocol event information from the protocol events of the protocol event logs 115 to perform various management functions (e.g., for topology reconciliation, for rebuilding protocol state and history, and the like). The presence of time-stamps and related protocol event information for protocol events within the protocol event logs 115 may simplify various management functions performed by the NMS 120 (e.g., topology reconciliation, rebuilding of protocol state and history, and the like). For example, construction of an (S,G) path history may be greatly simplified in this manner without missing short term events.

In one embodiment, the NMS 120 is configured to retrieve protocol event logs 115 of NEs 111 on demand. The NMS 120 may retrieve protocol event logs 115 on demand in response to any suitable trigger condition(s) (e.g., in response to a notification(s) from an NE(s) 111 during major events, on demand during troubleshooting being performed by the NMS 120, and the like, as well as various combinations thereof). This embodiment addresses the potential lag issue associated with periodic retrieval. It will be appreciated that stream-based capture of protocol events would eliminate any potential lag issue, as the NMS 120 would receive the protocol events via the stream as the protocol events occur; however, this would be at the expense of a more complex protocol event collection implementation (e.g., due to peak events).

In one embodiment, the NMS 120 is configured to retrieve portions of protocol event logs 115 of NEs 111. For example, the NMS 120 may be configured to retrieve protocol events from a certain date/time (e.g., based on the time stamping of protocol events within the protocol event logs 115 by the NEs 111), retrieve protocol events associated with a particular detected event or group of detected events, and the like, as well as various combinations thereof. The availability of such targeted ranges of protocol events to NMS 120 enables the NMS 120 to perform functions as deducing causes of problems, performing impact analysis, and the like, as well as various combinations thereof. In other words, NMS 120 is able to perform network surveillance. This provides significant advantages over existing protocol management schemes in which, at most, a management system only has access to snapshots of the network at particular points in time, with no knowledge of events occurring between the snapshots. The various embodiments depicted and described herein advantageously enable the NMS 120 to determine the current protocol state for any time and/or range of times, such that the NMS 120 is not limited only to the snapshots of existing protocol management schemes.

In one embodiment, the NMS 120 is configured to reconstruct at least some protocol event information based on topology information available to the NMS 120. In one embodiment, for example, this is done where an NE 111 suppresses one or more protocol events that are then reconstructed by the NMS 120. In this embodiment, the protocol event suppression rules on the NEs 111 and the NMS 120 are synchronized such that the NMS 120 knows the basis for suppression of protocol events and, thus, has a basis for reconstructing protocol events suppressed by the NEs 111. For example, an IIF down event will be related to a similar event on all (S,G) that were previously on the IIF interface.

In one embodiment, the NMS 120 is configured to enable/disable protocol event suppression rules in the NEs 111, thereby facilitating tuning of protocol event capture based on one or more factors (e.g., the roles of the NEs 111 within the network, the type of application(s) being supported by the NEs 111, the current state of the network, and the like, as well as various combinations thereof).

The NMS 120 may enable/disable protocol event suppression rules in the NEs 111 in response to any suitable trigger condition(s). In one embodiment, NMS 120 enables/disables protocol event suppression rules in response to requests from administrators of NMS 120. In one embodiment, the NMS 120 enables/disables protocol event suppression rules automatically, e.g., in response to detecting changes within the network (e.g., change of the role of an NE 111, change of a type of application being supported, and the like), in response to detecting particular types of events occurring within the network or expected to occur within the network, and the like, as well as various combinations thereof.

The NMS 120 may enable/disable protocol event suppression rules in the NEs 111 in any suitable manner. In one embodiment, NMS 120 may enable/disable a protocol event suppression rule(s) in an NE 111 by sending a message to the NE 111 identifying the protocol event suppression rule(s) that is to be enabled/disabled. The NMS 120 may enable/disable protocol event suppression rules in any other suitable manner.

In one embodiment, NMS 120 is configured to install new protocol event suppression rules on the NEs 111 and to remove existing protocol event suppression rules from the NEs.

The NMS 120 may install/remove protocol event suppression rules in response to any suitable trigger condition(s), e.g., such as described with respect the enabling/disabling of protocol event suppression rules on the NEs 111 by the NMS 120 and/or in response to any suitable trigger condition(s).

The NMS 120 may install/remove protocol event suppression rules in any suitable manner. In one embodiment, for example, NMS 120 may install a new protocol event suppression rule on an NE 111 by sending the new protocol event suppression rule to the NE 111 (for storage on the NE 111 and use by the NE 111 in suppressing protocol events). In one embodiment, for example, NMS 120 may remove an existing protocol event suppression rule from an NE 111 by sending, to the NE 111, an indication that the existing protocol suppression rule is to be deactivated or deleted from the NE 111. The NMS 120 may install/remove protocol event suppression rules in any other suitable manner.

In at least some such embodiments, the NMS 120 may install/remove protocol event suppression rules on a per-protocol basis.

It will be appreciated that installation/removal of protocol event suppression rules in this manner enables rule changes to be made on the NMS 120 and NEs 111 in concert, thereby providing an even greater level of control and tuning of protocol event suppression rules within the network.

Although primarily depicted and described herein with respect to embodiments in which the protocol event management capability is supported by each network element of the communication network, it will be appreciated that in other embodiments the protocol event management capability may be supported by only a subset of the network elements of the communication network.

Although primarily depicted and described hereinabove with respect to embodiments in which the protocol event management capability is provided by using a combination of protocol event capture and protocol event suppression, it will be appreciated that in other embodiments only the protocol event capture feature may be used or only the protocol event suppression feature may be used.

In other embodiments, various combinations of such alternatives may be used such that, in a network, any given network element may either (1) not support the protocol event management capability, (2) support only the protocol event capture feature, (3) support only the protocol event suppression feature, or (4) support both the protocol event capture and protocol event suppression features. The configuration of a network in this manner, which may be static or dynamic, may be based on any suitable factor or factors (e.g., the type of network, the size of the network, node types of the nodes included within the network, roles of the nodes included within the network, the current state of the network, and the like, as well as various combinations thereof).

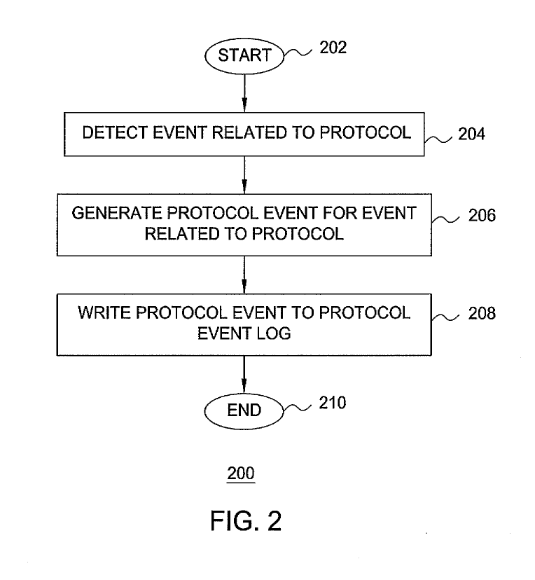

FIG. 2 depicts one embodiment of a method for providing protocol event logging at a network element of a communication network. The operation of method 200 of FIG. 2 may be better understood by way of reference to the description of the protocol event capture feature provided in conjunction with FIG. 1.

At step 202, method 200 begins.

At step 204, the network element detects an event related to a protocol running in the communication network.

At step 206, the network element generates a protocol event describing the detected event related to the protocol. As described herein, the generated protocol event may have various characteristics associated therewith (e.g., NMS-readable, time-stamped, including root cause information, and the like, as well as various combinations thereof).

At step 208, the network element writes the protocol event to a protocol event log maintained by the network element.

At step 210, method 200 ends.

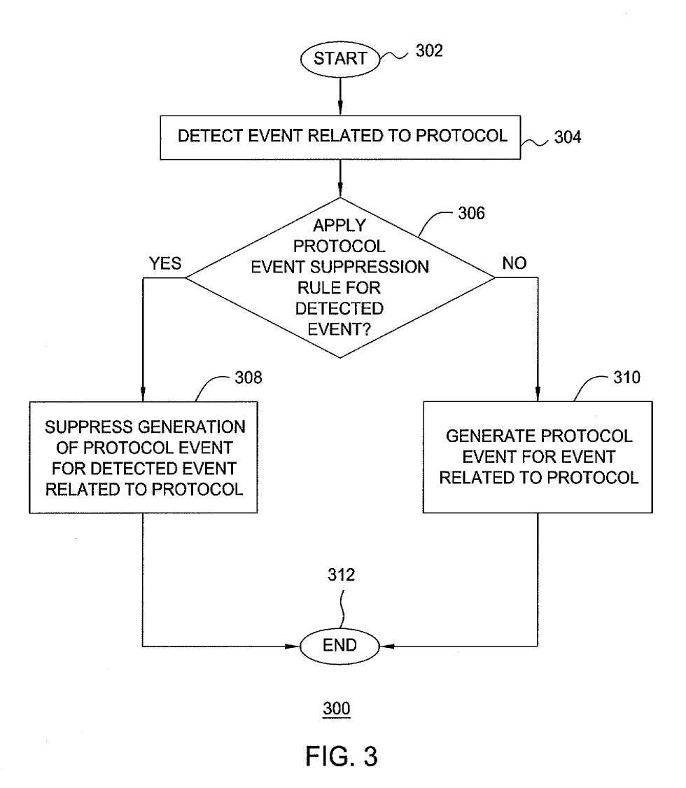

FIG. 3 depicts one embodiment of a method for providing protocol event suppression at a network element of a communication network. The operation of method 300 of FIG. 3 may be better understood by way of reference to the description of the protocol event suppression feature provided in conjunction with FIG. 1.

At step 302, method 300 begins.

At step 304, the network element detects an event related to a protocol running in the communication network.

At step 306, a determination is made by the network element as to whether to apply a protocol event suppression rule for the detected event related to the protocol. It will be appreciated that, since application of a protocol event suppression rule by the network element implies that the management system managing the network element will be able to reconstruct the suppressed protocol event, this determination also may be considered to be a determination as to whether the management system managing the network element is configured to reconstruct the protocol event that would have been generated in response to the detected event had protocol event suppression rule not been applied.

If a determination is made that a protocol event suppression rule is to be applied, method 300 proceeds to step 308, at which point generation of a protocol event, for the event related to the protocol, is suppressed by the network element.

If a determination is made that a protocol event suppression rule is to be applied, method 300 proceeds to step 310, at which point the network element generates a protocol event describing the detected event related to the protocol. The protocol event may be written to a protocol event log on the network element and/or propagated toward the management system.

From steps 308 and 310, method 300 proceeds to step 312, where the method 300 ends.

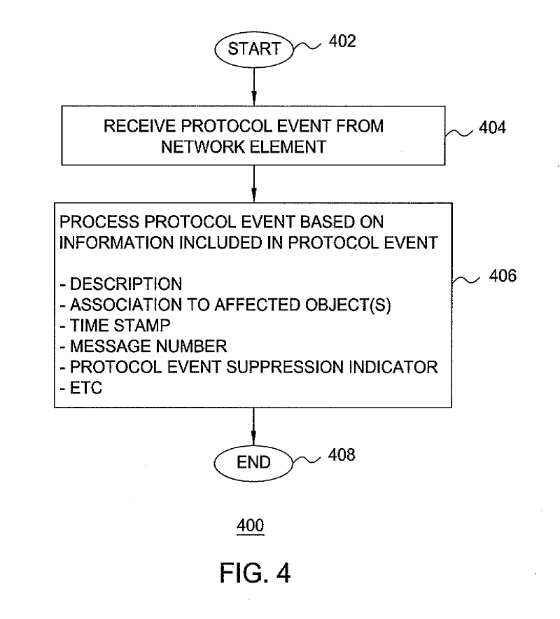

FIG. 4 depicts one embodiment of a method for processing a protocol event at a management system. The operation of method 400 of FIG. 4 may be better understood by way of reference to the description of the protocol event capture feature provided in conjunction with FIG. 1.

At step 402, method 400 begins.

At step 404, a protocol event is received at the management system from a network element.

At step 406, the protocol event is processed by the management system based on information included within the protocol event. As described herein, the information may include a description of the event associated with the protocol, an association of the event related to the protocol to at least one object impacted by the event related to the protocol, a time stamp, a message number, a protocol event suppression indicator, and the like, as well as various combinations thereof. The processing of the protocol event by the management system may include any suitable type(s) of processing. For example, the protocol event may be reconciled with a topology view of the management system deduced by the management system using any information suitable for deducing the topology view (e.g., from multicast topology tables, from SNMP traps, and the like, as well as various combinations thereof). For example, the protocol event may be ordered in relation to other protocol events based on information such as a time-stamp or message number of the protocol event. For example, one or more other protocol events may be reconstructed based on inclusion of a protocol event suppression indicator within the protocol event. For example, the protocol event may be processed to perform one or more management functions based on protocol event description information that is included within the protocol event. Various other types of processing may be performed as described herein with respect to FIG. 1.

At step 408, method 400 ends. Although depicted and described as ending, it will be appreciated that various other actions may be taken, such as storage of the protocol event, analysis of the protocol event, initiation of one or more management functions in response to receiving and/or based on the protocol event, and the like, as well as various combinations thereof.

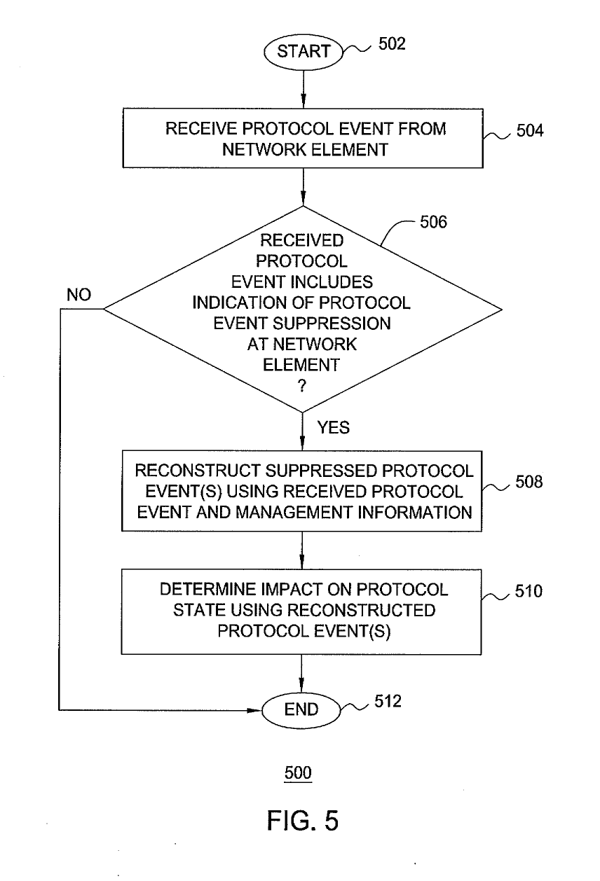

FIG. 5 depicts one embodiment of a method for processing a protocol event at a management system based on protocol event suppression. The operation of method 500 of FIG. 5 may be better understood by way of reference to the description of the protocol event suppression feature provided in conjunction with FIG. 1.

At step 502, method 500 begins.

At step 504, the management system receives a protocol event from a network element.

At step 506, the management system makes a determination as to whether the received protocol event includes an indication of protocol event suppression at the network element. If the received protocol event does not include an indication of protocol event suppression at the network element, method 500 proceeds to step 512, at which point method 500 ends. If the received protocol event includes an indication of protocol event suppression at the network element, method 500 proceeds to step 508.

At step 508, the management system reconstructs one or more suppressed protocol events using the received protocol event and, optionally, management information available on the management system (e.g., network topology information, protocol topology information, and the like, as well as various combinations thereof).

At step 510, the management system determines the impact on the protocol state of the protocol using the reconstructed protocol event(s). The determination of the impact on protocol state may include one or more of reconstructing the impact of the suppressed protocol event on the topology, determining the impact of the suppressed protocol event on various other related objects, and the like, as well as various combinations thereof.

At step 512, method 500 ends.

Although the protocol event management capability is primarily depicted and described herein within the context of management of multicast protocols of multicast networks, it will be appreciated that the protocol event management capability may be used for managing protocol events of any other suitable types of protocols in any other suitable types of communication networks. For example, in additional to multicast protocols such as PIM, IGMP, DVMRP, and the like, the protocol event management capability may be used for managing protocol events of other protocols such as various link layer network protocols (e.g., Spanning Tree Protocol (STP), Rapid STP (RSTP), Multiple STP (MSTP), Multiple Registration Protocol (MRP), Multiple Virtual Local Area Network (VLAN) Registration Protocol (MVRP), Multiple Media Access Control (MAC) Registration Protocol (MMRP), and the like), various Multiprotocol Label Switching (MPLS) related protocols (e.g., Resource Reservation Protocol—Traffic Engineering (RSVP-TE) and the like), and the like. Furthermore, more generally, the protocol event management capability may be used for managing protocol events for any node-local protocols having local network element state but not global network state, as well as any other types of protocols which may benefit from various functions of the protocol event management capability depicted and described herein and/or any other types of protocols which may utilize various functions of the protocol event management capability depicted and described herein.

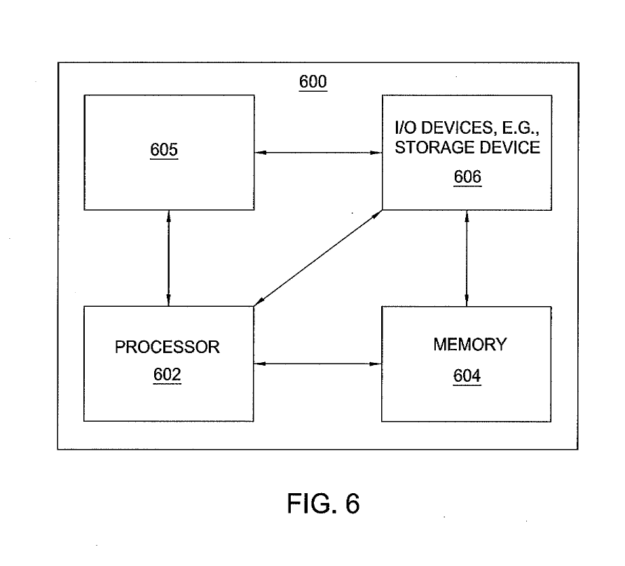

FIG. 6 depicts a high-level block diagram of a computer suitable for use in performing functions described herein.

As depicted in FIG. 6, computer 600 includes a processor element 602 (e.g., a central processing unit (CPU) and/or other suitable processor(s)), a memory 604 (e.g., random access memory (RAM), read only memory (ROM), and the like), a cooperating module/process 605, and various input/output devices 606 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the cooperating process 605 can be loaded into memory 604 and executed by processor 602 to implement the functions as discussed herein. Thus, cooperating process 605 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal-bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for protocol management, comprising:
detecting, at a network element of a communication network, an event related to a protocol running in the communication network;
generating a protocol event describing the event related to the protocol, wherein the protocol event comprises a description of the event related to the protocol and an association of the event related to the protocol to at least one object impacted by the event related to the protocol; and
writing the protocol event to a protocol event log maintained by the network element of the communication network.

2. The method of claim 1, wherein the protocol event is generated in a machine-readable format.

3. The method of claim 1, wherein the protocol event includes a time-stamp indicative of a local time of the protocol event on the network element.

4. The method of claim 3, wherein the time-stamp is provided by the network element.

5. The method of claim 1, wherein the protocol event comprises at least one of:
information adapted for use by a management system in deriving topology information of the communication network;
information related to the root cause of a change in the communication network; and
an indication that protocol event suppression has been used for suppressing at least one other protocol event.

6. The method of claim 1, wherein writing the protocol event comprises storing the protocol event in a file maintained by the network element.

7. The method of claim 1, wherein the event related to the protocol is a first event related to the protocol and the protocol event is a first protocol event, the method further comprising:
detecting, at the network element, a second event related to the protocol, wherein the second event related to the protocol is associated with the first event related to the protocol; and
suppressing generation of a second protocol event for the second event related to the protocol when a determination is made that a management system managing the network element is configured to reconstruct the second event related to the protocol.

8. The method of claim 1, further comprising:
receiving, from a management system, a request for information from the protocol event log of the network element;
identifying a portion of the protocol event log including protocol events logged in the protocol event log since the last time information from the protocol event log was provided to the management system; and
propagating the protocol events from the identified portion of the protocol event log from the network element toward the management system.

9. The method of claim 1, wherein the event related to the protocol is a first event related to the protocol and the protocol event is a first protocol event, the method further comprising:
detecting, at the network element, a second event related to the protocol,
generating a second protocol event describing the second event related to the protocol; and
propagating the second protocol event toward a management system.

10. An apparatus for protocol management, comprising:
a processor configured for
detecting, at a network element of a communication network, an event related to a protocol running in the communication network;
generating a protocol event describing the event related to the protocol, wherein the protocol event comprises a description of the event related to the protocol and an association of the event related to the protocol to at least one object impacted by the event related to the protocol; and
writing the protocol event to a protocol event log maintained by the network element of the communication network.

11. A method for protocol management, the method comprising:
detecting, at a network element of a communication network, an event related to a protocol running in the communication network; and
suppressing, at the network element, generation of a protocol event for the event related to the protocol when a determination is made that a protocol event suppression rule indicates that generation of a protocol event for the event related to the protocol is to be suppressed.

12. The method of claim 11, wherein the protocol event suppression rule is indicative to the network element that a management system managing the network element is configured to reconstruct the event related to the protocol without receiving the protocol event.

13. The method of claim 11, wherein the protocol event suppression rule is received at the network element from a management system managing the network element.

14. The method of claim 11, wherein the protocol event suppression rule is activated on the network element in response to a message received at the network element from a management system managing the network element.

15. The method of claim 11, wherein the protocol event suppression rule is associated with a role of the network element within the communication network.

16. The method of claim 11, wherein the event related to the protocol is a first event related to the protocol, the method further comprising:
detecting a second event related to the protocol; and
generating a protocol event describing the second event related to the protocol.

17. The method of claim 16, wherein the generated protocol event comprises a protocol event suppression indicator indicative of suppression of generation of the protocol event for the first event related to the protocol.

18. The method of claim 16, further comprising:
writing the generated protocol event to a protocol event log maintained by the network element.

19. The method of claim 16, further comprising:
propagating the generated protocol event toward a management system managing the network element.

20. An apparatus for protocol management, the apparatus comprising:
a processor configured for:
detecting, at a network element of a communication network, an event related to a protocol running in the communication network; and
suppressing, at the network element, generation of a protocol event for the event related to the protocol when a determination is made that a protocol event suppression rule indicates that generation of a protocol event for the event related to the protocol is to be suppressed.
